(19) United States
(12) Patent Application Publication
(10) Pub. No.: US 2009/0328163 A1
(43) Pub. Date: Dec. 31, 2009

(54) SYSTEM AND METHOD USING STREAMING CAPTCHA FOR ONLINE VERIFICATION

(75) Inventor: Scott E. Preece, Champaign, IL (US)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/164,040

(22) Filed: Jun. 28, 2008

(51) Int. Cl. G09G 5/00; H04L 9/32

(52) U.S. Cl. 726/5; 345/629

(57) ABSTRACT

An improved system and method using a streaming captcha for online verification is provided. A request sent by a client device may be received by a server to serve a streaming captcha to the client device. A server may compose a streaming captcha by superimposing a captcha character string on a video. The streaming captcha may be streamed to the client device. The streaming captcha may be displayed on the client device, and a character string input by a user may be received in response to display of the streaming captcha. The character string received may be sent to the server for verification. The server may verify that the character string received is the same as the captcha character string displayed in the streaming captcha. The server may then send an indication of the verification to the client device.

### FIELD OF THE INVENTION

The invention relates generally to computer systems, and more particularly to an improved system and method using a streaming captcha for online verification.

### BACKGROUND OF THE INVENTION

A captcha is an image that includes one or more words that are typically distorted in order to make it difficult for an automated agent or machine process to decipher, but easy for a human to decipher. A captcha is generally used to distinguish a human user from automated agent or machine process in order to eliminate robots from acquiring or submitting information online. A captcha may usually take the form of an image of a word that is mangled in some way and may be used in transactions that may require a human present, such as signing up for an online account, for instance. In this case, a captcha may be displayed, and, as part of the transaction, the text of the captcha must be supplied as input by presumably a human. In addition to being used to verify that a human may be involved in an online transaction or communication rather than an automated agent, captchas may also be used to avoid certain types of spam. For example, when a user enters a comment into an online system, it is increasingly common for the online system to send a captcha in order to verify that an automated agent is not being used to enter an advertising link automatically on a large number of comments in the online system.

However, captchas have been defeated by social engineering where unwitting third parties may decipher the captcha as part of a machine process. Captchas have also been defeated by image analysis. What is needed is a way to provide a captcha that is easy for a human to decipher but is not easily defeated by social engineering or by applying image analysis.

### SUMMARY OF THE INVENTION

Briefly, the present invention may provide a system and method using a streaming captcha for online verification. In various embodiments, a client having a web browser may be operably coupled to a server for requesting a streaming captcha. The server may include a captcha serving engine that provides services to send a streaming captcha to a web browser operating on a client device for display as part of a web page and provides services to validate a character string received in response to display of the streaming captcha. The captcha serving engine may include an operably coupled streaming captcha composer that may superimpose a sequence of characters from a captcha character string on a video to compose the streaming captcha. The captcha serving engine may also include an operably coupled captcha streamer that may stream the streaming captcha to the web browser operating on the client for display as part of the web page. The captcha serving engine may also include an operably coupled response verifier that verifies a character string received from the client in response to display of the streaming captcha.

The present invention may effectively provide a streaming captcha that is easy for a human to decipher but difficult to be defeated by an automated agent. In various embodiments, a request sent by a client device may be received by a server to serve a streaming captcha to the client device. A server may compose a streaming captcha by superimposing a captcha character string on a video. A timer may be set and the streaming captcha may be streamed to the client device. The streaming captcha may be displayed on the client device, and a character string input by a user may be received in response to display of the streaming captcha. The character string received may be sent to the server for verification. The server may verify that the character string received is the same as the captcha character string displayed in the streaming captcha and may also verify that the response was sent within a predetermined time limit. The server may then send an indication of the verification to the client device.

Advantageously, the present invention may flexibly support various implementations of a streaming captcha. For instance, a streaming captcha may be composed by superimposing a captcha character string on a video stream so that the character string appears in the foreground part of the video stream. In an embodiment, the background part of the video stream may vary. Moreover, a character may change progressively into the next character in the sequence of characters in the captcha character string. Or an animation may be generated to display the sequence of characters from the captcha character string. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components using a streaming captcha for online verification, in accordance with an aspect of the present invention;

FIG. 3 is a flowchart generally representing the steps undertaken in one embodiment for using a streaming captcha for online verification, in accordance with an aspect of the present invention;

FIG. 4 is a flowchart generally representing the steps undertaken in one embodiment to display a streaming captcha on a client device for online verification, in accordance with an aspect of the present invention; and

FIG. 5 is a flowchart generally representing the steps undertaken in one embodiment on a server to stream a captcha for online verification, in accordance with an aspect of the present invention.

### DETAILED DESCRIPTION

### Exemplary Operative Environment

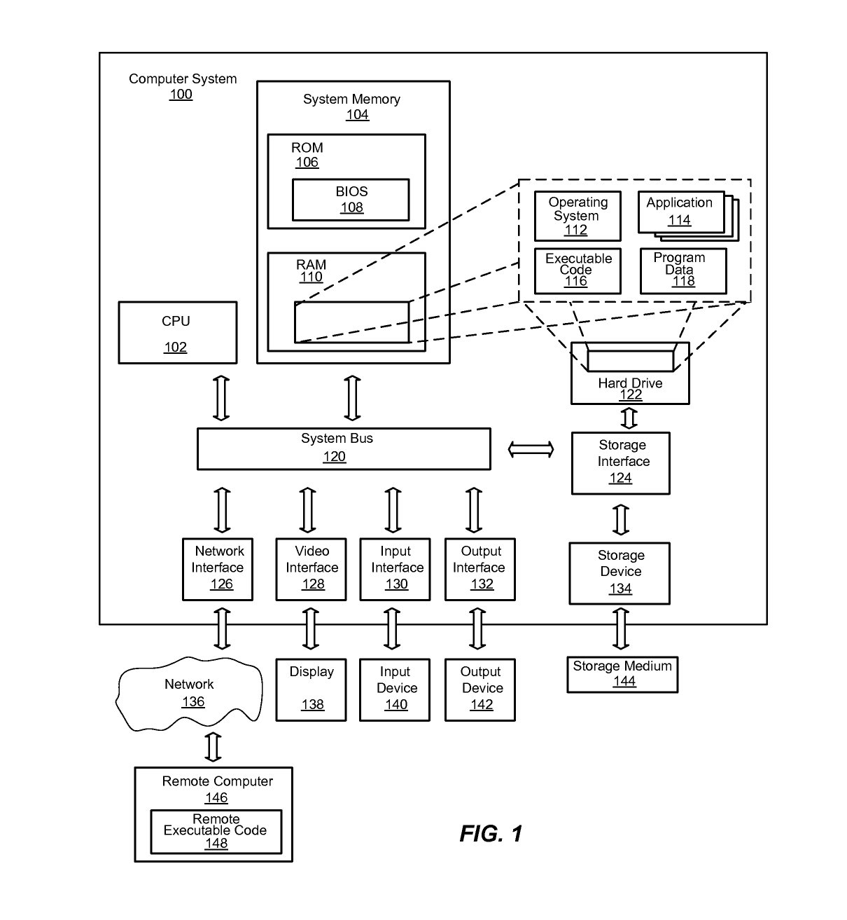

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations. Examples of well known computing systems, environments, and/or configurations that may be suitable for use with the invention include, but are not limited to: personal computers, server computers, hand-held or laptop devices, mobile phones, digital music players, tablet devices, headless servers, multiprocessor systems, microprocessor-based systems, set top boxes, programmable consumer electronics, network PCs, minicomputers, mainframe computers, and distributed computing environments that include any of the above systems or devices.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Streaming Captcha for Online Verification

The present invention is generally directed towards a system and method for using a streaming captcha for online verification. A streaming captcha, as used herein, may mean a streaming video that includes one or more character strings that are typically distorted in order to make it difficult for an automated agent or machine process to decipher, but easy for a human to decipher. In various embodiments, a video with a captcha character string displayed in a sequence may be composed to stream to a client device. The video with the captcha character string may be streamed to the client device, and a character string input by a user may be received in response to display of the streaming captcha. The character string input by the user may be verified to be the captcha character string displayed in the streaming captcha.

As will be seen, many online applications may use a streaming captcha to distinguish a human user from automated agent or machine process in order to eliminate robots from acquiring or submitting information online. As will be understood, the various block diagrams, flow charts and scenarios described herein are only examples, and there are many other scenarios to which the present invention will apply.

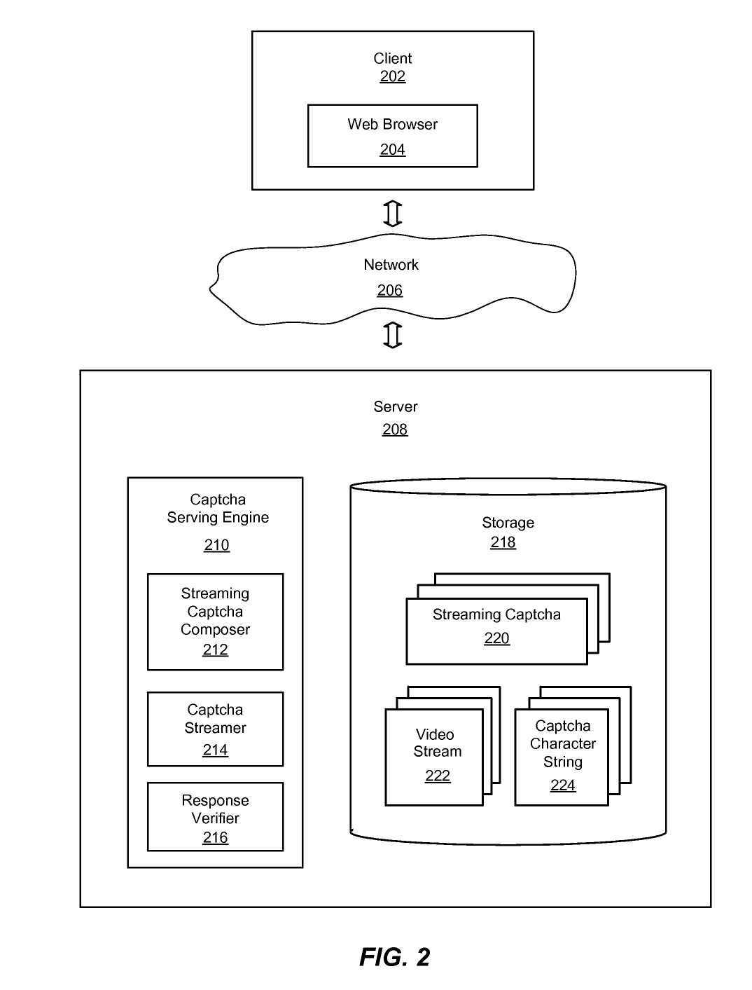

Turning to FIG. 2 of the drawings, there is shown a block diagram generally representing an exemplary architecture of system components using a streaming captcha for online verification. Those skilled in the art will appreciate that the functionality implemented within the blocks illustrated in the diagram may be implemented as separate components or the functionality of several or all of the blocks may be implemented within a single component. For example, the functionality for the streaming captcha composer 212 may be implemented as a separate component from the captcha serving engine 210. Or the functionality of the captcha streamer 214 may be implemented in the same component as the streaming captcha composer 212. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 208 may be any type of network such as a local area network (LAN), a wide area network (WAN), or other type of network. A web browser 204 may execute on the client computer 202 and may include functionality to receive a request input by a user to perform a transaction and to send the request to a server to perform the requested transaction. In general, the web browser 204 may be any type of interpreted or executable software code such as a kernel component, an application program, a script, a linked library, an object with methods, and so forth. In various embodiments, other applications may be used for sending a request to perform a transaction, including an email application requesting a user to login, an ecommerce application responding to a request for product information, and an online application for signing up for an online account, and so forth.

The server 208 may be any type of computer system or computing device such as computer system 100 of FIG. 1. In an embodiment, the server 208 may include a captcha serving engine 210 that provides services to send a streaming captcha to a web browser operating on a client device for display as part of a web page and services to validate a character string received in response to display of the streaming captcha. In particular, the captcha serving engine 210 may include streaming captcha composer 212 operably coupled to the captcha serving engine 210 that superimposes a sequence of characters from a captcha character string 224 on a video stream 222 to compose the streaming captcha. The captcha serving engine 210 may also include a captcha streamer 214 that streams the streaming captcha to the web browser operating on the client device for display as part of the web page. The captcha serving engine 210 may also include a response verifier that verifies a character string received in response to display of a streaming captcha is the same as the captcha character string 224. Each of these modules may also be any type of executable software code such as a kernel component, an application program, a linked library, an object with methods, or other type of executable software code. The server 208 may be operably coupled to computer-readable storage media such as storage 218 that may store streaming captchas 220 that may be composed of a video stream 222 and a captcha character string 224.

There may be many online applications which may use a streaming captcha to verify the presence of a human user. For example, an online application may use the present invention to verify that a user is signing up for an online account. Similarly, ecommerce applications may use the present invention when responding to a request for product information to verify that a user is requesting the product information. For any of these online applications, a streaming captcha may be used to distinguish a human user from an automated agent or machine process in order to eliminate robots from acquiring or submitting information.

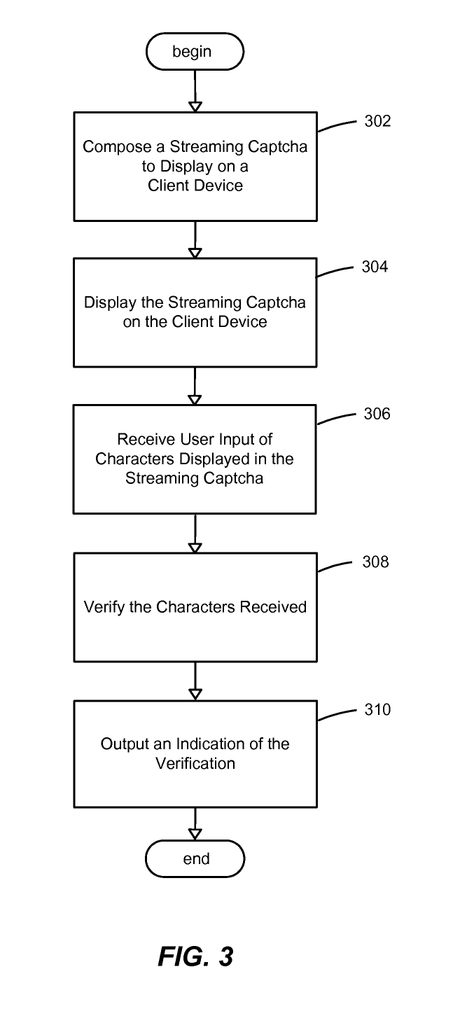

FIG. 3 presents a flowchart generally representing the steps undertaken in one embodiment for using a streaming captcha for online verification. At step 302, a streaming captcha may be composed to stream to a client device. In an embodiment, a streaming captcha may be composed by superimposing the characters of a captcha character string in a sequence on a video stream so that the character string appears in the foreground part of the video stream. In various embodiments, the background part of the streaming video may also vary. Moreover, transition effects from one character to the next in the sequence of characters of the captcha character string may be used in an embodiment, so that a character may morph into the next character in the sequence. Or an animation may be generated to display the sequence of characters from the captcha character string.

At step 304, the streaming captcha may be streamed to the client device. At step 306, a character string input by a user may be received in response to display of the streaming captcha. In an embodiment, each of the characters in the captcha character string could be required to be input by a user after the character was displayed in the streaming captcha and before the next character in the sequence may be displayed. In such an embodiment, the streaming captcha may stream a video clip with the character repeatedly until a character is received in response to displaying the character in the captcha character string for verification. In other embodiments, a character string may be received after the sequence of characters in the captcha character string was displayed in the streaming captcha.

At step 308, the character string input by the user may be verified to be the captcha character string displayed in the streaming captcha, and an indication of the verification may be output at step 310. For example, if the character string input by the user is the same as the captcha character string displayed in the streaming captcha, an acknowledgement of successful verification may be sent to the client device. If the character string is not the same as the captcha character string, a failure message may be sent to the client device.

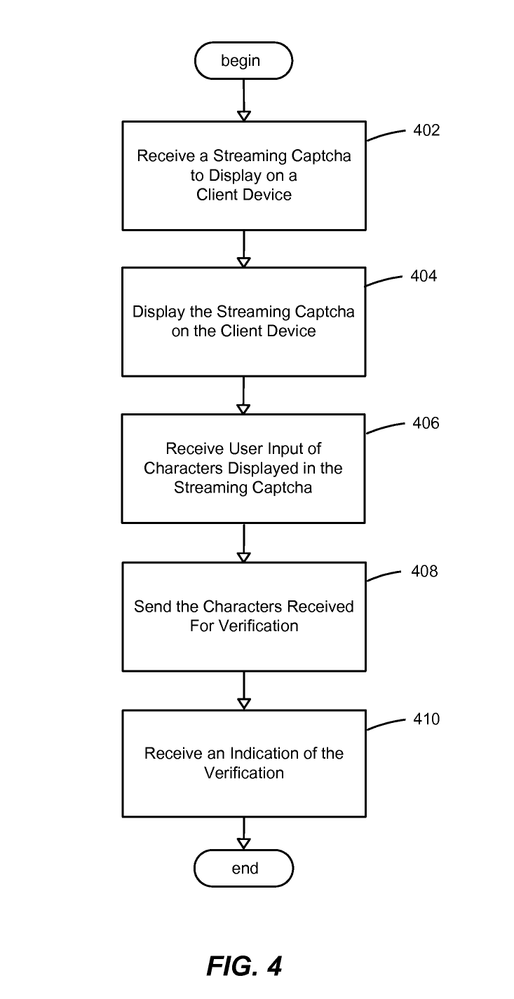

FIG. 4 presents a flowchart generally representing the steps undertaken in one embodiment to display a streaming captcha on a client device for online verification. At step 402, a streaming captcha may be received by a client device and the streaming captcha may be displayed at step 404 on the client device. In an embodiment, the streaming captcha may be displayed by a web browser operating on the client device. In other embodiments, an online application such as an ecommerce application may display the streaming captcha on the client device.

At step 406, a character string input by a user may be received in response to display of the streaming captcha. In an embodiment, a user may be prompted to input each character in a sequence of captcha characters after the character has been displayed. At step 408, the character stream input by the user may be sent to a server for verification, and an indication of the verification may be received at step 410. If an acknowledgement is received that indicates the character string is the same as the captcha character string, a web browser or online application may allow a transaction to proceed, information to be acquired, information to be submitted, or other requested action that initiated online verification by a streaming captcha.

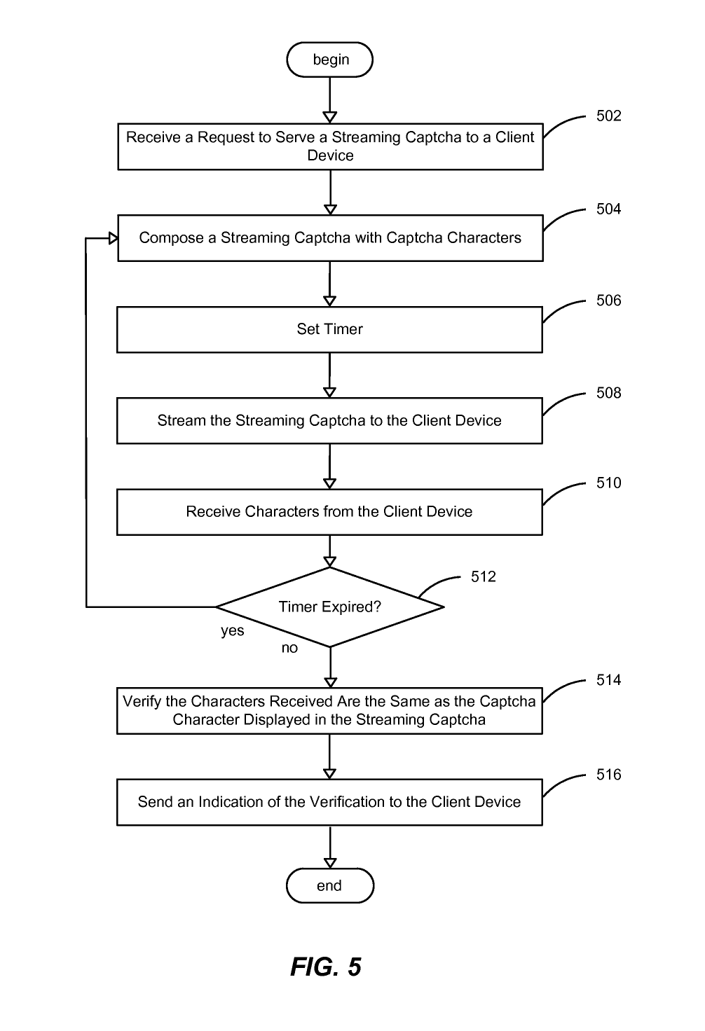

FIG. 5 presents a flowchart generally representing the steps undertaken in one embodiment on a server to stream a captcha for online verification. At step 502, a request may be received to serve a streaming captcha to client device. For example, a request from a web browser operating on a client device may be received in an embodiment by a server to serve a streaming captcha. At step 504, a streaming captcha may be composed that includes a sequence of characters of a captcha character string. In an embodiment, a streaming captcha may be composed by superimposing the characters of a captcha character string in a sequence on a video stream so that the character string appears in the foreground part of the video stream. In various embodiments, the background part of the video stream may vary continuously to make it harder for an automated tool to identify the individual elements of a streaming captcha such as image boundaries. Additionally, the way each of the characters in the character sequence is presented may vary. For instance, there may be transition effects between the characters, including a change in size, position, and shape. Any transition effects may be used, including fading in and out, between a character and the next character in the presentation of the sequence of the captcha character string.

At step 506, a timer may be set. By applying timing constraints on the user's response, the time available to an attacker to solve the captcha may be limited. Such timing constraints may make it much harder to defeat the streaming captcha by social engineering. Moreover, applying timing constraints may also limit the amount of time that a robot would have to break the video stream into analyzable fragments for image analysis. At step 508, a streaming captcha may be streamed to the client device and a character string input by the user may be received at step 510.

At step 512, it may be determined whether the timer expired. If so, processing may continue at step 504 and another streaming captcha may be composed. In an embodiment, a few additional different streaming captchas may be composed in the event the timer continues to expire, otherwise a failure message may be sent to a client device. If it may be determined that the timer has not expired, then the character string received may be verified at step 514 to be the same captcha character string displayed in the streaming captcha. The server may send an indication of the verification to the client device at step 516 and processing may be finished.

Thus the present invention may be used by online applications to make it difficult for social engineering and automated image analysis to circumvent online verification of a user by a captcha. Advantageously, the background part of the video stream may vary continuously to make it harder for an automated tool to identify the individual elements of a streaming captcha such as image boundaries. Moreover, transition effects may vary the way each of the characters in the character sequence is presented. By applying timing constraints on the user's response, it may also make it much harder to defeat the streaming captcha by social engineering or image analysis.

As can be seen from the foregoing detailed description, the present invention provides an improved system and method using a streaming captcha for online verification. A request sent by a client device may be received by a server to serve a streaming captcha to the client device. A server may compose a streaming captcha, and the streaming captcha may be streamed to the client device. The streaming captcha may be displayed on the client device, and a character string input by a user may be received in response to display of the streaming captcha. The character string received may be sent to the server for verification that the character string received is the same as the captcha character string displayed in the streaming captcha. The server may then send an indication of the verification to the client device. Many online applications may use a streaming captcha to distinguish a human user from automated agent or machine process. Accordingly, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for online verification, comprising:
captcha serving engine that provides services to send a streaming captcha to a web browser operating on a client device for display as part of a web page and services to validate a character string received in response to display of the streaming captcha; and
a storage operably coupled to the captcha serving engine that stores a video and a captcha character string.

2. The system of claim 1 further comprising a streaming captcha composer operably coupled to the captcha serving engine that superimposes a sequence of characters from the captcha character string on a video to compose the streaming captcha.

3. The system of claim 2 further comprising a captcha streamer operably coupled to the streaming captcha composer to stream the streaming captcha to the web browser operating on the client device for display as part of the web page.

4. The system of claim 1 further comprising a response verifier operably coupled to the captcha serving engine that verifies the character string received in response to display of the streaming captcha is the same as the captcha character string.

5. A computer-implemented method for online verification, comprising:
composing a streaming captcha to display a sequence of characters in a captcha character string;
streaming the streaming captcha to a client device;
receiving a character string in response to display of the streaming captcha; and
outputting an indication of verification of the character string received in response to display of the streaming captcha.

6. The method of claim 5 wherein composing the streaming captcha to display the sequence of characters in the captcha character string comprises superimposing the sequence of characters from the captcha character string on a video to generate the streaming captcha.

7. The method of claim 6 wherein outputting the indication of verification of the character string received in response to display of the streaming captcha comprises sending an acknowledgement of verification to the client device.

8. The method of claim 5 wherein outputting the indication of verification of the character string received in response to display of the streaming captcha comprises verifying the character string received in response to display of the streaming captcha is the same as the sequence of character in the captcha character string.

9. The method of claim 6 further comprising:
setting a timer to expire after a time period designated for receiving the character string from the client device;
determining whether the timer expired before receiving the character string from the client device; and
verifying the character string from the client device is the same as the sequence of character in the captcha character string if the timer did not expire before receiving the character string from the client device.

10. The method of claim 9 further comprising:
composing a streaming captcha to display a sequence of characters in a captcha character string;
streaming the streaming captcha to a client device;
receiving a character string in response to display of the streaming captcha; and
outputting an indication of verification of the character string received in response to display of the streaming captcha.

11. The method of claim 5 further comprising displaying the streaming captcha on the client device.

12. The method of claim 5 further comprising sending from the client device the character string received in response to display of the streaming captcha to a server for verification.

13. The method of claim 5 further comprising receiving on the client device an indication of verification of the character string received in response to display of the streaming captcha.

14. The method of claim 5 wherein composing a streaming captcha to display a sequence of characters in a captcha character string comprises generating an animation to display the sequence of characters from the captcha character string.

15. The method of claim 6 wherein superimposing the sequence of characters from the captcha character string on the video to generate the streaming captcha comprises randomly selecting the video from a plurality of videos and randomly selecting the captcha character string from a plurality of captcha character strings.

16. The method of claim 6 wherein superimposing the sequence of characters from the captcha character string on the video to generate the streaming captcha comprises superimposing the sequence of characters from the captcha character string on a video with a varying video stream.

17. The method of claim 6 wherein superimposing the sequence of characters from the captcha character string on the video to generate the streaming captcha comprises transforming a character in the sequence of characters into another character in the sequence of characters.

18. A computer-readable medium having computer-executable instructions for performing the method of claim 5.

19. A computer system for online verification, comprising:
means for composing a streaming captcha to display a sequence of characters in a captcha character string;
means for streaming the streaming captcha to a client device;
means for receiving a character string in response to display of the streaming captcha; and
means for outputting an indication of verification of the character string received in response to display of the streaming captcha.

20. The computer system of claim 19 further comprising:
means for requesting the streaming captcha to display the sequence of characters in the captcha character string;
means for receiving the streaming captcha to display the sequence of characters in the captcha character string;
means for displaying the sequence of characters in the captcha character string;
means for sending a character string input in response to display of the streaming captcha for verification; and
means for receiving an indication of verification of the character string input in response to display of the streaming captcha.
